(19) United States
(12) Patent Application Publication
(10) Pub. No.: US 2009/0292463 A1
(43) Pub. Date: Nov. 26, 2009

(54) System and method for determining routing information

(75) Inventor: Robert Gregory Chase, Coarsegold, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: XORA, INC.

(21) Appl. No.: 12/454,720

(22) Filed: May 21, 2009

Related U.S. Application Data
(60) Provisional application No. 61/128,403, filed on May 21, 2008.

(51) Int. Cl. G01C 21/36

(52) U.S. Cl. 701/201; 701/200

(57) ABSTRACT

A system and method for determining an optimal set of routes from an origin to one or more destinations. The system comprises a reverse geo-code database of closest intersections for one or more locations of a particular geographical region, a matrix generator, and a vehicle routing problem solver. The matrix generator creates a set of shortest routes among the possible routes between the origin location and the one or more destination locations. The shortest routes are determined by calculating a distance from a first location to a first nearest artery, a distance from a second location to a second nearest artery, and from the first nearest artery to the second nearest artery. The vehicle routing problem solver generates an optimal set of routes connecting the one or more locations by combining the one or more shortest routes.

### CROSS-REFERENCE TO RELATED APPLICATIONS

This Application claims benefit of U.S. Provisional Patent Application Ser. No. 61/128,403, filed May 21, 2008, which is herein incorporated by reference.

### BACKGROUND OF THE INVENTION

1. Field of the Invention

Embodiments of the present invention relate to systems that provide location based services and, more particularly, to a system and method for determining routing information.

2. Description of the Related Art

Many service companies require movement of a business resource (an employee, a driver, a service vehicle, etc.) to one or more destination locations. For example, courier or package delivery services, appliance repair and maintenance services, and many other such services, need their employees and/or vehicles to visit multiple destinations in a particular geographical region, such as a city or a town, and the like. It is generally desirable to decrease the time taken and/or the distance traveled to reach the multiple destination locations. This helps in minimizing the cost of travel to the service company. The time and distance parameters are dependent upon the number of destination locations and the distance to be traveled. Put differently, the itinerary of the resource is an important factor in determining the costs to the business.

Conventional techniques for route planning include on-vehicle navigation devices that may require significant time or processing power to create a set of optimized routes. These techniques are not affordable for a small business, nor are they able to support internet based routing.

Accordingly, there is a need for an improved system and method that provides optimal routing information.

### SUMMARY

Embodiments of the invention comprise a system and method for determining an optimal set of routes from an origin to one or more destinations. The system comprises a reverse geo-code database of closest intersections for one or more locations of a particular geographical region, a matrix generator, and a vehicle routing problem solver. The matrix generator creates a set of shortest paths among possible paths between the origin location and the one or more destination locations. The shortest paths are determined by calculating a distance from a first location to a first nearest artery, a distance from a second location to a second nearest artery, and from the first nearest artery to the second nearest artery. The vehicle routing problem solver generates an optimal set of routes connecting the one or more locations by combining the one or more shortest paths.

The method comprises creating a set of shortest paths among each of the one or more possible routes and generating an optimal set of routes. The shortest paths are created between the origin location and the one or more destination locations. Each path is determined by calculating a first distance from a first location to a first nearest artery, a second distance from a second location to a second nearest artery, and a third distance from the first nearest artery to the second nearest artery. The optimal set of routes is generated by combining the one or more shortest paths.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram representation of an optimal set of routes determining system in accordance with embodiments of the present invention;

FIG. 2 is a block diagram representation of a reverse geo-coder database in accordance with embodiments of the present invention;

FIG. 3 is a flow diagram representation of a method for generating a reverse geo-code database, according to one embodiment of the present invention;

FIG. 4 is a flow diagram representation of a method for retrieval of a reverse geo-code, according to one embodiment of the present invention;

FIG. 5 is a flow diagram representation of a matrix generator operation according to one embodiment of the present invention;

FIG. 6 is an illustration of an outcome for shortest path generation of the method of operation of a matrix generator of FIG. 4, according to one embodiment of the present invention; and

FIG. 7 is flow diagram of a VRP solver operation according to one embodiment of the present invention.

### DETAILED DESCRIPTION

Various businesses deliver services at different locations, such as customer locations (courier services, telephone repair, cable installation, etc.), or business resource locations (ATM, vending machines, etc.), among others. An employee of the business may travel to multiple locations during a particular stretch of time to deliver the services. For example, customers of a goods delivery services business provide delivery data (destination location address, time of delivery, and the like) for the goods to be delivered. To enable cost effective and timely service, the goods (or “packages”) need to be delivered in the most efficient manner possible. Accordingly, optimal route instructions need to be provided to a driver or an employee of the business such that the routes optimize the travel time, distance traveled, and/or the cost involved. Moreover, when the destinations are to be visited by a fleet of vehicles, they must be optimally grouped into routes that minimize the cost of operating the fleet.

In one scenario, and as an example, a driver starts at an origin location, and is provided multiple packages to be delivered. The driver is required to deliver the multiple packages to at least one destination location assigned to the multiple packages. The driver may also be required to return to the origin location after delivering the multiple packages.

In one embodiment of the present invention, the determination of the optimal set of routes comprises determining closest intersections for all locations (origin and destination), determining a shortest path between the locations and the closest intersections, determining a shortest path between each pair of the closest intersections, and determining a set of paths connecting the closest intersections such that the overall set of routes is optimal, and saves cost for the business. According to the embodiment, each location is connected to the closest intersection, the closest intersections are grouped into a set of optimal routes, and the closest intersections of each path are connected to provide an optimal route. Generally speaking, the various embodiments of the invention compute a route from a first location to a second location, where the first and second locations may represent an origin location, a destination location, or any combination thereof or a combination of a plurality of origin and destination locations.

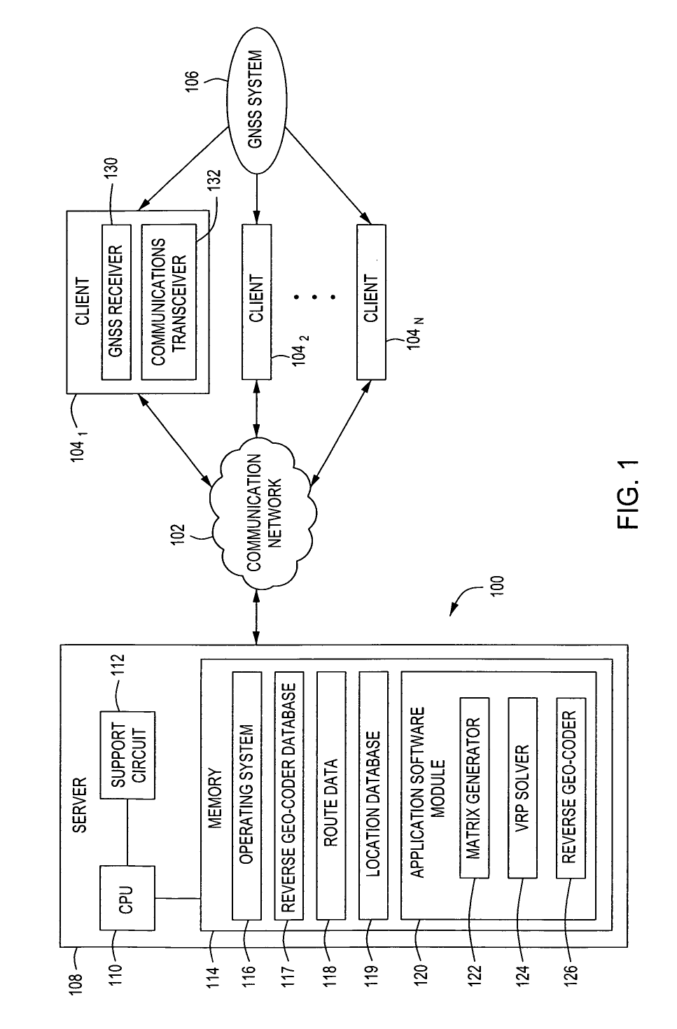

FIG. 1 is a block diagram of a system 100 for determining an optimal set of routes (hereafter, the system 100) in accordance with an embodiments of the present invention. The system 100 includes clients 104₁, 104₂, . . . , 104ₙ, (hereafter, the clients 104), a server 108 and a communication network 102. The server 108 includes a processing unit 110, support circuits 112 and a memory 114. The memory 114 includes an operating system 116, a reverse geo-code database 117, route data 118, a location database 119 and an application software module 120. The application software module 120 includes a matrix generator 122, a vehicle routing problem (VRP) solver 124 and a reverse geo-coder 126.

In one embodiment, each client 104 comprises a Global Navigation Satellite System (GNSS) receiver 130 and a communication transceiver 132. The GNSS receiver 130 processes signals from the GNSS system 106 (for example, GPS, GLONASS, GALILEO and the like) to determine the location of the client 104. The communication transceiver 104 is used to report the position to the server 108. The GNSS system 106 is coupled to the clients 104 through transmissions from the system 106. The clients 104 are further coupled to the server 108 via the communication network 102. The client 104 may obtain a location through other techniques, such as cellular signal triangulation, inertial navigation, and the like.

In an embodiment that uses a GNSS receiver, The GNSS system 106 is configured to distribute GNSS signals through GNSS satellites. The GNSS signals from a plurality of satellites are received by the clients 104. The clients 104 are equipped with, for example, mobile tracking devices (GNSS receivers 130) included in a cell phone or other similar communication devices such as a radio or laptop computer. In one embodiment, the clients 104 are generally a GNSS enabled cellular telephone. Such telephones are well-known and commercially available. In other embodiments, the client 104 may comprise a personal navigation device (PND). Each of the mobile tracking devices calculates the current location of each of the client devices 104, such as the vehicles delivering the packages of goods.

The clients 104 and the server 108 are coupled through the communication network 102 to transmit information, such as the current location information, among others. The information may be transmitted from the clients 104 to the server 108 and/or vice-versa. The communication network 102 may include, without limitation, a Global System for Mobile communication (GSM) network, a Code Division Multiple Access (CDMA) network and the Internet, BLUETOOTH, or a combination of the above, among others. The current location information is sent to the server 108 through the communication network 102 and routing instructions are sent from the server 108 to the client 104.

In one embodiment, the server 108 is a location-based services (LBS) server that is configured to utilize a current location of a client 104 to provide navigation services. In accordance with one embodiment of the invention, the server 108 determines the optimal set of routes for the clients 104 using the current location information and transmits route instructions to the clients 104 through the communication network 102. The processing unit 110 of the server 108 may be one or more commercially available microprocessors or microcontrollers. Alternatively, the processing unit 110 may comprise one or more application specific integrated circuits. The support circuits 112 of the server 108 comprise well known circuits to support the functionality of the processing unit 110. The support circuits 112 comprise one or more clock circuits, buses, input/output circuits and devices, power supplies, network cards, cache, and the like.

The memory 114 of the server 108 stores the reverse geo-code database 117, the location database 119, a set of routes 118, and software such as an operating system 116 and an application software module 120.

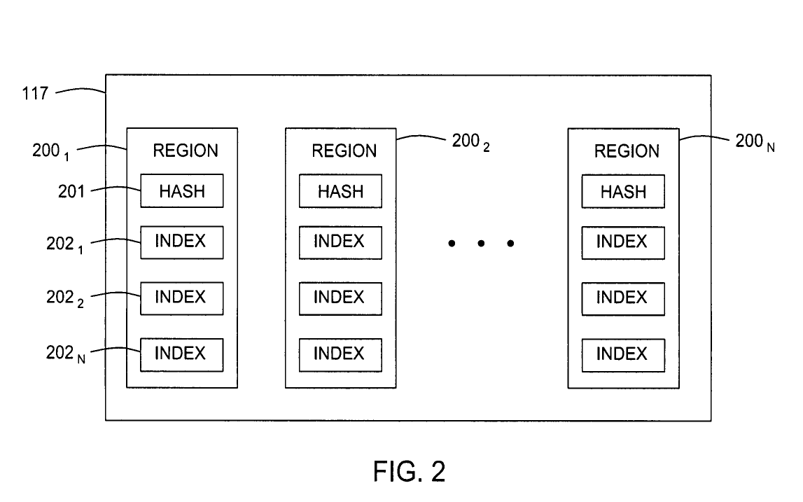

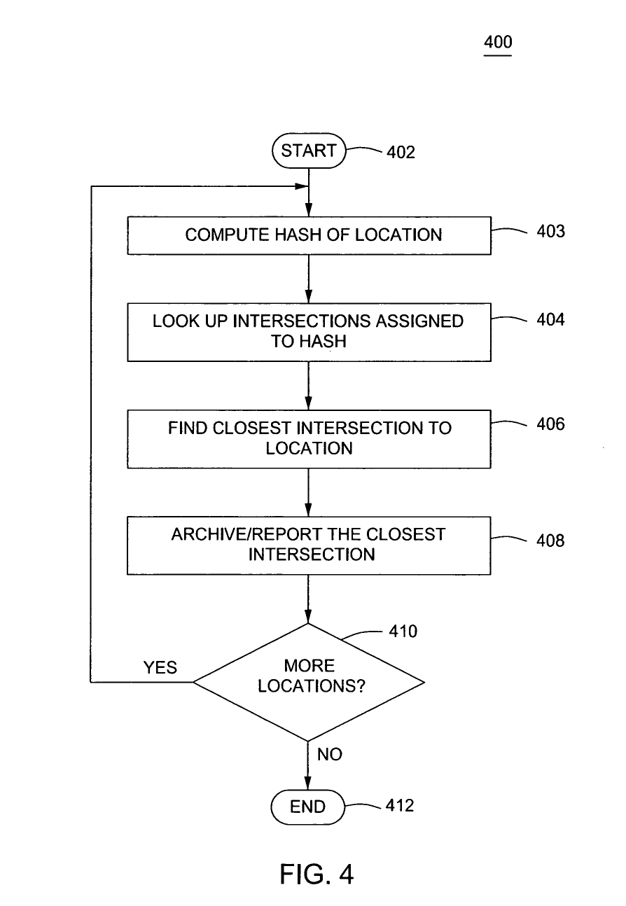

The application software module 120 comprises a matrix generator 122, a vehicle routing problem (VRP) solver 124, and a reverse geo-coder 126. The reverse geo-coder 126 determines a nearest intersection to a particular location using the reverse geo-coder database 117. The reverse geo-coder database 117 is discussed further with respect to FIG. 2. The process by which the reverse geo-coder 126 determines the nearest intersection to a location is discussed further with respect to FIG. 4. The matrix generator 122 calculates the best path between any two locations, building a set of route data 118. The best path may be defined as the faster or shortest path, depending upon how the matrix generator 122 is configured. The matrix generator 122 may also include additional configuration options such as an instruction to avoid toll roads. The VRP solver 124 determines an optimal set of routes connecting the origin and the destination locations from the set of route data 118. The optimal set of routes is provided to the clients 104.

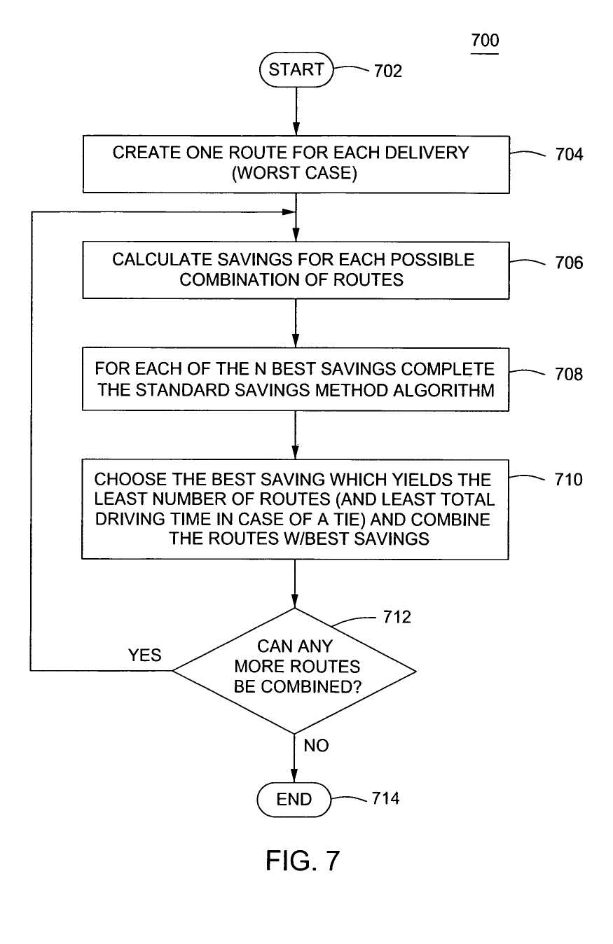

The memory 114 also stores a set of routes 118. The set of routes 118 represent street routes from one location to another location. The set of routes 118 are optimized to create an optimal set of routes (also stored within the set of routes 118) by the method discussed with respect to FIG. 7.

The memory 114 also stores a location database 119. The location database 119 contains data representing locations and roads in a given geographic region. For example, the location database 119 may correspond to a map of a city, state, or country. In some embodiments, the locations are stored as data representing the latitude and longitude coordinate pair of the location. This location database 119 is populated with the unrounded latitude and longitude of each intersection within that region.

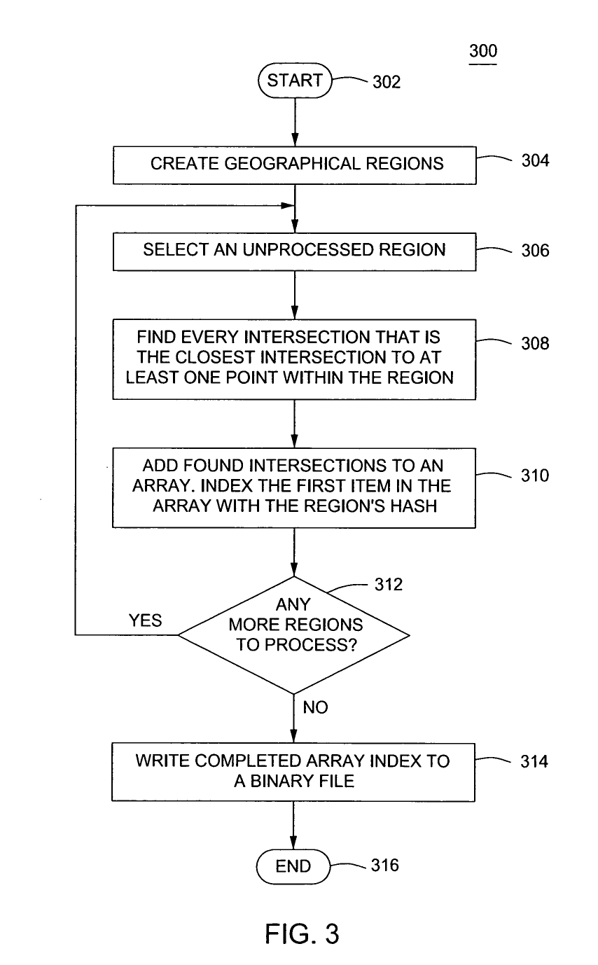

FIG. 2 is a block diagram of the reverse geo-code database 117. The reverse geo-code database 117 is comprised of one or more geographic regions 200. In one embodiment, each geographic region 200 contains a hash 201 and an array one or more indices 202. The indices 202 correspond to a physical location within the location database 119 for each street intersection in the geographic region 200. The indices stored in each region 200 correspond to latitude and longitude pairs that resolve to the same hash 201. The hash 201 is a calculated value unique to the region. In one embodiment, the hash 201 is calculated by multiplying the latitude, longitude and a constant and rounding to a whole number. The constant is used to scale the distance between different hash values prior to rounding, so that distinct regions are created by the rounded hashes. A larger constant results in larger number of regions being created. While the multiplication of the latitude and longitude is offered as an exemplary method of creating the hash 201, one of ordinary skill in the art would recognize that any method that is likely to produce a unique identifier for a given set of coordinates would also provide a suitable hash. Each hash 201 is unique for a given geographic region 200. The method by which the reverse geo-code database 117 is generated is discussed further with respect to FIG. 3.

FIG. 3 is a flow diagram of a method 300 for generating the reverse geo-code database 117. The reverse geo-code database is accessible by the reverse geo-coder 126. The method 300 begins at step 302 where a location database 119 has been identified for reverse geo-coding.

The method 300 then proceeds to step 304 by creating data structures corresponding to geographical regions that together will contain all of the latitude and longitude points within a given search area to be indexed (such as a city, state, country, continent, and the like), of the street intersection locations within the location database 119. Regions are determined based upon boundaries, so any given point within the search space may be indexed to some region. In one embodiment, the given search area is split into squares corresponding to particular latitude and longitude lengths. For example, the region may be divided into squares of 1 degree of latitude and 1 degree of longitude on a side. At step 306, an unprocessed region is selected.

At step 308, the method computes the closest intersections to some point within the selected region. The method examines each intersection within the region and intersections located within a certain distance from the boundary markers of the region to determine which intersection is the nearest intersection to at least one point in the region. For example, the method may determine the closest point in the region for all intersections located within 100 miles of the region boundaries. The nearest intersection for each point is determined using boundaries between nearest intersections, so it is unnecessary to measure every point within the region at a certain granularity.

At step 310, the newly processed region is added to an array indexed by computed hash value. The intersections may be stored as indices 202 corresponding to elements in the location database 119. At step 312 the method 300 determines whether there are any additional regions to process. If there are, the method 300 repeats starting at step 306. If there are no more regions to process, at step 314 the method saves the completed list and its index to the reverse geo-code database 117 and terminates.

FIG. 4 is a flow diagram of a method 400 to find the closest intersection from a target latitude and longitude location, for example, an origin location or a destination location, according to an embodiment of the present invention. The method 400 starts at step 402 and proceeds to step 403. At step 403, the method determines the hash value of the longitude and latitude pair of the given target location by multiplying the longitude, the latitude, and constant and rounding to the nearest whole number. The constant must be the same value used to calculate the hash with respect to FIG. 3. As above, the hash value may be generated in another manner, so long as the hash formula produces a value that can be indexed and measured against the hash values created for locations in the location database 119. The rounded hash represents the predefined region within which the target location lies. The method accesses the region 200 associated with the calculated hash. To find the closest intersections, the method 400 accesses the intersections within the location database 119 with the accessed region 200. The process to match a hash value representing the client location with the database values is nearly instantaneous. However, since rounded hash values are used, a plurality of intersections typically match a given location represented by a particular hash value.

At step 404, method searches through the intersections associated with the region corresponding to the hash value of the target location. At step 406, the method calculates the distance between the target location and the intersections to find the closest intersection to the target. The method uses the indices 202 from the reverse geo-code database to retrieve the latitude and longitude associated with the intersections from the location database 119. The method then uses the Haversine formula to determine the distance from the target location to the intersections. The Haversine formula is generally used in the art to calculate distances between two locations when given the latitude and longitude of each.

Once the distances are calculated, the method selects the intersection with the shortest calculated distance from the target location by comparing the computed distances. At step 408, the coordinates of the closest intersection to the target location are archived or reported.

At step 410, a determination is made whether more computations for other target locations are necessary. If the nearest location to all target locations has been identified, the method ends at step 412. If there are more locations for which to calculate the nearest intersection, the method 400 returns to the step 404. The result of executing the method 400 is a list of the nearest intersection location to the current location of the client as well as a nearest intersection location of each destination to be visited.

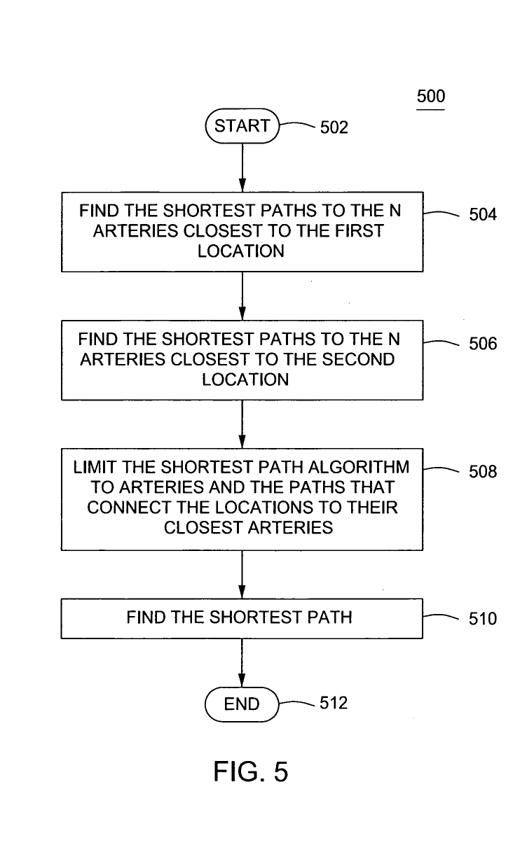

FIG. 5 is a flow diagram of a method 500 illustrating an operation of a matrix generator, such as the matrix generator 122, according to an embodiment of the present invention. The matrix generator computes the fastest path between each and every pair of a set of locations including the vehicles starting and ending locations, such as between a first location and every other planned destination. As used in context with the matrix generator, the term “fastest path” means a path to be taken by a vehicle requiring the least amount of travel time, such that the path is restricted to travel on major roads or highways and only those minor streets that must be traveled to connect the origin and destination to a major street or highway. However, one of ordinary skill in the art would recognize that the method 500 could be modified to use other criteria for determining the best path, such as shortest physical distance (irrespective of travel time), most inexpensive (avoiding toll roads), and the like. In one embodiment, the matrix generator uses an enhancement to Dijkstra's shortest path algorithm to speed up calculation of the fastest path between each and every pair of the set of the locations, for example, between closest intersection of the depot location and closest intersection of a service location or between the closest intersections of a pair of service locations.

The method 500 starts at step 502 and proceeds to step 504, where the shortest paths to one or more arteries nearest the first location are identified by determining the distance from the target location to the arteries located within the region (an artery is defined as a street or highway where traffic is allowed to travel at least 45 miles per hour). At step 506, the method starts at the target location and uses Dijkstra's Shortest Path Algorithm to calculate paths to the arteries stored in the location database 119. The method calculates connections to arteries until a certain number of connecting paths are calculated. The number of calculated paths may be raised to increase the chance of determining an optimal route to the nearest artery, or it may be lowered to conserve computing resources.

At step 508, the method limits the search for the shortest path between the first location and the second location to arteries and the shortest paths which connect the two locations to their closest one or more arteries. At step 510, the fastest path between the two locations, is found. The method 500 then ends at step 512. The matrix generator speeds up the calculation of the shortest path by limiting the potential search space to routes from the locations to arteries, and from the first location's nearest artery to the second location's nearest artery.

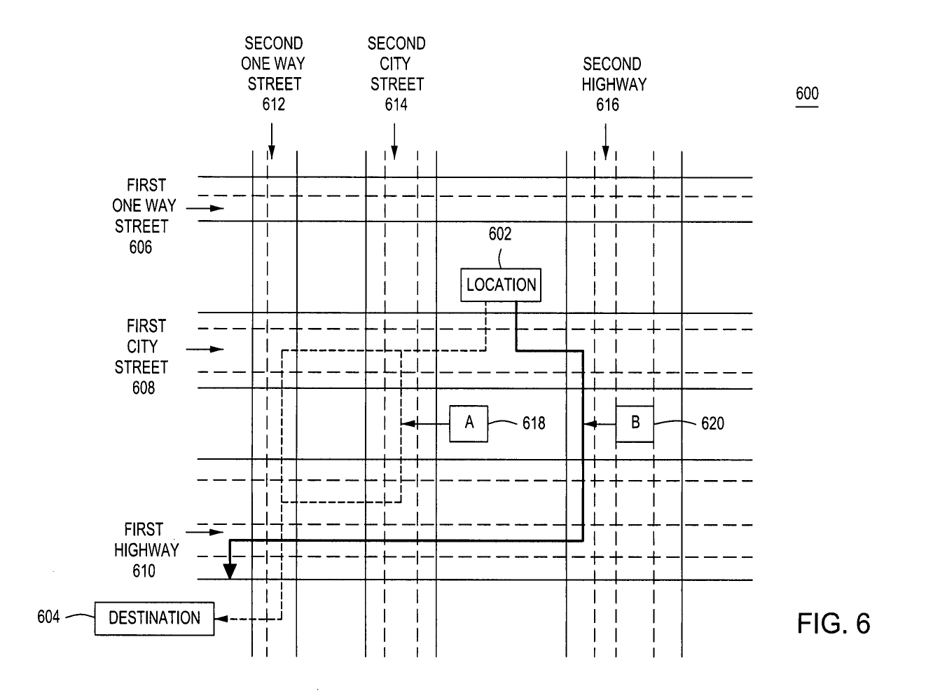

FIG. 6 is an illustration of an outcome 600 of calculating a shortest path between two locations, according to an embodiment of the present invention. The shortest path is calculated by the matrix generator 122. FIG. 6 illustrates a location 602, a destination 604, a first one way street 606, a first city street 608, a first highway 610, a second one way street 612, a second city street 614, a second highway 616, a traditional search path (A) 618 and a new limited search path (B) 620. All the streets illustrated in the FIG. 6 cross one another; the second one way street 612 crosses the first one way street 606, the first city street 608 and the first highway 610, and the like. The location 602 lies in the region in-between the first one way street 606, the first city street 608, the second city street 614 and the second highway 616. The location 602, here, refers to the region where a vehicle, such as the client 104, is standing or available. The destination 604 lies near the first highway 610 and the second one way street 612. The destination 604 refers to the region where the vehicle has to reach.

According to one embodiment, arteries near the location 602 are identified. As above, connecting paths to the arteries stored in the location database 119 area are calculated, and the shortest path is selected using Dijkstra's Shortest Path Algorithm. A certain number of paths to arteries is calculated, and the shortest path is chosen. The number of calculated paths may be raised or lowered to increase the maximum search space or conserve computing resources, respectively. An artery near the location 602 in the given illustration is second highway 616. Arteries near the destination 604 are then identified. An artery near the destination 604 is the first highway 610. A search for the fastest path from the nearest intersection of the start location 602 and the nearest intersection to the destination location 604 is limited to those paths which travel only those arteries which connect the identified closest arteries; for example, the search is limited to the second highway 616 and the first highway 610. In this manner the fastest path between two locations is determined by breaking the route into three pieces: the start location to the nearest first artery, the destination location to the nearest second artery, and the shortest path between the first and second artery. The fastest path between the location 602 and the destination 604 is computed by the matrix generator of the present invention by searching only the path (B) 620 in the given illustration. The path (A) 618 is a path which was also searched when not using the matrix generator of the present invention. The fastest path between the location 602 and the destination 604 is thereby computed while greatly reducing the number of paths searched.

Accordingly, the fastest path is calculated between each target location and the closest intersections. Then, an optimal set of routes is calculated by joining all the closest intersections. Further, the set of routes includes the path from each closest intersection to the target location and back to the closest intersection. These routes are then sent via the network from the server to the various clients.

FIG. 7 is a flow diagram of a method 700 illustrating the operation of the VRP solver 124, according to one embodiment of the present invention. The VRP solver calculates the set of optimal routes spanning the multiple target locations, using the fastest paths provided by the matrix generator. The VRP solver is an enhancement to the Standard Savings Method, generally known in the art of finding route information. The method 700 starts at step 702 and proceeds to step 704, where it creates one route for each delivery (the worst case scenario where the vehicle returns to the starting point after visiting each destination). The method 700 begins with the worst possible scenario, that a separate route and vehicle will service each delivery, and then incrementally improves that plan by combining the pair of routes whose combination yields the greatest time savings.

At step 706, the method calculates the savings achieved by combining each possible combination of two routes. As discussed below, in order to calculate the savings, the method uses a Balas/Simonetti's Travelling Salesman Problem (TSP) Time Linear Solver for problems with precedence constraints. The Balas/Simonetti TSP algorithm is an algorithm well-known in the art of route planning that uses dynamic programming concepts to solve a shortest path problem in linear time. For further reference, please see E. Balas and M. Simonetti, “Linear Time Dynamic-Programming Algorithms for New Classes of Restricted TSPs: A Computational Study,” INFORMS Journal on Computing, vol 13, no 1, December 2000, pp. 56-75.

At step 708, the method increases the size of the search space in the VRP solver 124 by using the Standard Savings Method algorithm to determine more than one best route combination. The Standard Savings Method uses a limited search space to calculate the optimal paths. As an example, for one origin location and fifteen destination locations to which a fleet has to deliver goods, there can be one-hundred twenty ways to combine two of the fifteen worst case routes into one trip. In the conventional Standard Savings Method, the time savings of each different route combination is calculated. Out of all the different combinations, the pair of routes whose combination yields the greatest savings is combined into a single route, replacing the component routes in the set of routes. This process is then repeated; the computation of the savings of all the combinations of the new route with each of the other routes is performed. The combination of routes that yields the best savings is again combined, and the set of routes is again recomputed. Thus, the algorithm moves forward without considering any combination other than the one pair which yields the greatest savings. Thus the conventional savings method is limited in its search space.

The method 700 advantageously enhances the Standard Savings Method by expanding the potential search space to include the pair of routes with the second, third, . . . and Nth best savings; for each of these additional combinations the algorithm is completed as usual, and the number of routes and total driving time is stored for each of these additional results. The enhanced method 700 then selects the pair of routes whose combination resulted in the creation of the least number of routes (or in case of a tie, the least total driving time) to determine a “best” savings.

In certain cases, the search spaces may be limited such that the number of calculations stays within acceptable performance levels of the computer performing the computation or expanded to create a more optimal solution. Accordingly, the search spaces may be limited or expanded by the number of best savings N to consider before choosing the best pair, or how many levels to skip after picking a best pair, among various others. Where N>1, there is a high probability that a route more optimal than that obtained by the conventional savings method will be found. By expanding the search space to combine more than the route yielding the overall highest time savings, the enhanced method 700 increases the likelihood of determining an optimal route.

At step 710, the one of the best N savings that yielded the least number of routes (and least total driving time in case of a tie) is chosen and irrevocably combined.

At step 712, the method determines whether or not any routes can be combined by measuring the lengths of a route created by combining the best route determined at step 710 with the additional routes. If additional combinations of routes will result in a reduced number of routes, increased time savings, and fit within user constraints (such as a defined maximum number of routes, maximum route length, maximum route distance, etc.), then the method 700 returns to step 706. Otherwise, the method 700 terminates at step 714 with the optimized set of routes stored in memory. As a result of using the Balas/Simonetti TSP solver to combine two routes into an optimally sequenced new one, the VRP handles any new precedence constraint by simply adding that constraint to the Balas/Simonetti TSP. Moreover, each new precedence constraint that is added both speeds up the algorithm and improves the likelihood of computing the optimal result.

The various embodiments discussed herein provide for several advantages. For example, the different embodiments discussed herein help in reducing cost of travel by optimizing the paths traveled by the client, for example, the employees of the service company. Also, the present invention provides updated routing information to the client, as needed.

In the foregoing specification, specific embodiments of the present invention have been described. However, one of ordinary skill in the art will appreciate that various modifications and changes can be made without departing from the spirit and scope of the present invention as set forth in the various embodiments described above. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described in the figures.

1. A system for determining an optimal set of routes from an origin location to one or more destination locations comprising:
a reverse geo-code database of closest intersections for a set of one or more locations of a particular geographical region;
a matrix generator for creating a set of shortest paths among the possible paths between the origin location and the one or more destination locations wherein the shortest paths are determined by calculating a first shortest distance from a first location to a first nearest artery, a second shortest distance from a second location to a second nearest artery, a third shortest distance from the first nearest artery to the second nearest artery, and combining the first shortest distance, the second shortest distance, and the third shortest distance; and
a vehicle routing problem solver for generating an optimal set of routes connecting the one or more destination locations by combining the one or more shortest paths.

2. The system of claim 1, further comprising one or more client devices for receiving the optimal set of routes from the vehicle routing problem solver.

3. The system of claim 2, wherein the client devices provide a set of location information used to determine the origin location.

4. The system of claim 3, wherein the client devices compute the current location via a GNSS system.

5. The system of claim 1, wherein the reverse geo-coder database comprises at least one hash value representing the at least one street intersection.

6. The system of claim 5, wherein the hash values are determined by multiplying the latitude and longitude coordinates of the at least one street intersection.

7. A method for determining an optimal set of routes linking an origin location and one or more destination locations performed by a special-purpose computer programmed by an application software module comprising:
creating a set of shortest paths among each of the one or more possible paths between the origin location and the one or more destination locations, wherein the shortest paths are determined by calculating a first shortest distance from a first location to a first nearest artery, a second shortest distance from a second location to a second nearest artery, a third shortest distance from the first nearest artery to the second nearest artery, and combining the first shortest distance, the second shortest distance, and the third shortest distance; and
generating an optimal set of routes connecting the one or more destination locations by combining the one or more shortest paths.

8. The method of claim 7; wherein the generating step further comprises calculating an optimal set of routes using an enhanced Standard Savings Method comprising:
calculating a time savings for each of one or more possible combinations of the routes comprising the set of shortest routes;
executing the Standard Savings Method algorithm on each of one or more shortest combinations of the one or more possible combinations; and
choosing the shortest combination which yields a least number of routes;
adding the chosen shortest combination to the set of routes; and
repeating until the set of shortest routes can no longer be combined.

9. A computer program executed on a processor to perform the method of claim 7.

10. A computer program executed on a processor to perform the method of claim 8.

11. The method of claim 7, further comprising sending the determined optimal set of routes to one or more client devices.

12. A computer program executed on a processor to perform the method of claim 11.

13. The method of claim 11, wherein the client device computes location information used to determine the origin location.

14. The method of claim 13, wherein the origin location is computed using signals from a GNSS system.

15. The method of claim 7, wherein the creating step further comprises
generating a hash value for each of the origin location and destination locations and
comparing the generated hash value with a reverse geo-code database to determine a nearest intersection.

16. The method of claim 15, wherein the reverse geo-code database comprises one or more intersection hash values for each of one or more intersections in a region.

17. The method of claim 15, wherein the hash generating step further comprises multiplying a latitude coordinate and a longitude coordinate of a target location to create the hash value.

18. The method of claim 15, wherein the geo-code database comprises one or more hash values corresponding to one or more street intersections.

19. A system for determining an optimal set of routes from an origin location to one or more destination locations comprising:
means for creating a set of shortest paths among the possible routes between the origin location and the one or more destination locations wherein the shortest paths are determined by calculating a first shortest distance from a first location to a first nearest artery, a second shortest distance from a second location to a second nearest artery, a third shortest distance from the first nearest artery to the second nearest artery, and adding the first shortest distance, the second shortest distance, and the third shortest; and
means for generating an optimal set of routes connecting the one or more locations by combining the one or more shortest paths.

20. The system of claim 19, further comprising means for sending the optimal set of routes to one or more client devices.
